(19) United States
(12) Patent Application Publication
(10) Pub. No.: US 2024/0074618 A1
(43) Pub. Date: Mar. 7, 2024

(54) BOTTOM-DRIVEN FOOD PROCESSING DEVICE ATTACHMENT AND RELATED SYSTEMS AND METHODS

(71) Applicant: SharkNinja Operating LLC, Needham, MA (US)

(72) Inventors: Noah Weinstock, Needham, MA (US); Pierce Barnard, Manly (AU); Travis Marks, Needham, MA (US)

(73) Assignee: SharkNinja Operating LLC, Needham, MA (US)

(21) Appl. No.: 17/903,394

(22) Filed: Sep. 6, 2022

(51) Int. Cl. A47J 43/08; A47J 43/046; A47J 43/07

(52) U.S. Cl. CPC A47J 43/085; A47J 43/046; A47J 43/0722

(57) ABSTRACT

An attachment for a food processing device includes a base attachment housing having a first port configured to receive a drive coupler of a detachably connectable motorized base housing and a second port configured to receive a central rotating member of a detachably connectable accessory attachment. The base attachment housing also includes a drive transfer assembly configured to couple the first port to the second port. The drive transfer assembly is configured to transfer rotational motion of the drive coupler to drive rotational motion of the central rotating member of the accessory attachment when the motorized base housing and the accessory attachment are connected to the first port and second port respectively.

### FIELD

The subject disclosure relates to food processing devices, and more particularly, to food processing devices having a base attachment housing that is detachably connectable to a motorized base housing and to an accessory attachment to provide bottom-driven rotation to the accessory attachment.

### BACKGROUND

A wide variety of devices for food processing exist. However, each food processing device, by itself, tends to serve only a small number of food processing needs. This can be due to limitations in the mechanical layout, which limits the way the device can be operated used in different food processing situations. Further, food processing devices can also be limited in the extent to which they allow for the attachment of different mixing, blending, whisking, or other types of food processing ends that can be attached for various purposes. This created a need for many different devices to be purchased and maintained by an individual or business to effectively attend to all food processing needs that may arise.

Certain existing kitchen tools have been developed that allow for interchangeably connecting various types of attachments capable of performing different types of food processing functions. In particular, top-driven kitchen tools (e.g., immersion blenders) sometimes allow for more attachment compatibility than bottom-driven kitchen tools (e.g., food processers). However, most top-driven kitchen tools lack versatility in the types of vessels and lids that can be used in connection with the device. Accordingly, there is a need for a bottom-driven food processing device or kitchen tool capable of more versatile, evolvable, and flexible attachment capabilities.

### SUMMARY

The present disclosure addresses technical problems associated with existing food processing devices and/or kitchen tools by enabling versatile attachment configurations for bottom-driven food processing devices. It should be appreciated that the disclosed food processing devices are not limited to devices that are commonly referred to as “food processing devices,” but rather can include any device that performs any form of processing food, for example, by performing one or more of the foregoing: mixing, blending, pureeing, slicing, dicing, chopping, grating, shaving, peeling, grinding, squeezing, folding, kneading, other forms of processing food, or any suitable combination of the foregoing.

Illustrative food processing attachments as well as related devices and methods are described that enable versatile attachment configurations and provide bottom-driven food processing capabilities. The disclosed food processing attachments include a base attachment housing having a first port, a second port, and a drive transfer assembly configured to couple the first port to the second port. The first port is configured to receive a drive coupler of a detachably connectable motorized base housing. The second port is configured to receive a central rotating member of a detachably connectable accessory attachment. The drive transfer assembly transfers rotational motion of the drive coupler to drive rotational motion of the central rotating member of the accessory attachment when the motorized base housing and the accessory attachment are connected to the first port and second port, respectively. The drive transfer assembly may be implemented with a belt drive and/or a gear train, as desired.

In some implementations, the accessory attachment includes a vessel and the central rotating member is positioned to rotate within the vessel. The accessory attachment may include a blender, chopper, mixer, frother, vacuum sealer, grinder, food processor, juicer, spiralizer, and/or a direct prepper.

In certain implementations, the drive coupler rotates about a first axis and the central rotating member rotates about a second axis, and the first axis is parallel to the second axis. In some such implementations, the first axis is offset from the second axis.

The second port may include one or more interlocks to detect the accessory attachment coupled to the base attachment housing. In some such implementations, the motorized base housing may be configured to adjust a speed of the drive coupler based on the accessory attachment detected.

In another aspect, a food processing device having a motorized base, an accessory attachment, and a base attachment housing is described. The motorized base housing includes a drive coupler configured to rotate about a first axis and the accessory attachment includes a central rotating member configured to rotate about a second axis. The base attachment housing includes a first port configured to receive the drive coupler and a second port configured to receive the central rotating member. The base attachment housing also includes a drive transfer assembly arranged to transfer rotational motion of the drive coupler to drive rotational motion of the central rotating member. In some such implementations, the first axis may be parallel to and offset from the second axis. In these and other implementations, the drive transfer assembly may include a belt drive or a gear train.

In yet another aspect, a method of using a food processing device is described. The method includes connecting a drive coupler of a motorized base housing to a first port of a base attachment housing, connecting a central rotating member of an accessory attachment to a second port of the base attachment housing, providing a drive transfer assembly within the base attachment housing arranged to transfer a motion of the drive coupler to a motion of the central rotating member, and activating the motorized base housing to drive rotational movement of the central rotating member via the drive transfer assembly.

### BRIEF DESCRIPTION OF THE DRAWINGS

So that those having ordinary skill in the art to which the disclosed system pertains will more readily understand how to make and use the same, reference may be had to the following drawings.

FIG. 1A is a top perspective view of a food processing attachment configured in accordance with the subject technology that includes a base attachment housing and an exemplary accessory attachment;

FIG. 1B is a front view of the food processing attachment of FIG. 1A;

FIG. 1C is a side view of the food processing attachment of FIG. 1A;

FIG. 2A is a perspective view of an exemplary base attachment housing;

FIG. 2B is a cut-away view of the base attachment housing of FIG. 2A;

FIG. 2C is a top view of the base attachment housing of FIG. 2A, illustrating features of the first port and the second port;

FIG. 3A is a side perspective view of an exemplary motorized base housing;

FIG. 3B is a bottom view of the motorized base housing of FIG. 3A;

FIG. 4A is a perspective view of an isolated accessory attachment for a food processing device configured in accordance with the subject technology;

FIG. 4B is a bottom perspective view of the accessory attachment of FIG. 4A;

FIG. 4C is a cut-away view of the accessory attachment of FIG. 4A;

FIG. 5A is a perspective view of a food processing device configured in accordance with the subject technology;

FIG. 58 is a side view of the food processing device of FIG. 5A;

FIG. 6 shows a block diagram of a computer system; and

FIG. 7 includes a flow diagram of a process for assembling and using the disclosed food processing devices.

### DETAILED DESCRIPTION

The subject technology overcomes many of the prior art problems associated with food processing devices and/or kitchen tools by enabling versatile attachment arrangements and providing bottom-driven attachment possibilities, all powered by a detachable motorized base. Conventional bottom-driven food processors are limited in the type of vessel attachments that can be used with the associated motor mechanism. Although some immersion blenders are compatible with different types of food processing attachments, immersion blenders are top-driven, which significantly restricts the type of vessel and lid that can be used as well as the type of processing tasks that may be performed. In contrast with previous arrangements powered by a detachable motorized base housing (e.g., an immersion blender or a bottom-driven food processor), the subject disclosure provides a food processing attachment that detachably receives a motorized base housing and transfers its rotational motion to a detachable accessory (e.g., a vessel or other type of accessory) to deliver numerous bottom-driven capabilities for the accessory. The bottom-driven arrangement provided by the disclosed attachments enable a wider range of possible accessory outputs, all from a single main base. The disclosed food processing attachments use a belt drive or gear train system to provide rotation to an accessory attachment offset from the motor base. The disclosed bottom-driven system thus allows for a wide range of vessels and other types of accessory attachments to be used through a single base housing that is compatible with a removable motorized base.

In some implementations, the disclosed food processing attachment includes a base attachment housing with a first port configured to receive a feature(e.g., a drive coupler) of a detachably connectable motorized base housing and a second port configured to receive a feature (e.g., a central rotating member) of a detachably connectable accessory attachment. The base attachment housing also includes a drive transfer assembly configured to couple the first port to the second port. The drive transfer assembly transfers rotational motion of the motorized base housing to drive rotational motion of the accessory attachment when the motorized base housing and the accessory attachment are connected to the first port and second port, respectively. The subject technology involves food processing device that include the disclosed food processing attachment(s) as well as related methods of use.

As will be appreciated upon consideration of the subject disclosure, the present technology provides a food processing device with various removable and bottom-driven accessory attachments that may be coupled to a single base and powered by a detachable motorized base housing. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e., where an “upper” part must always at a higher elevation).

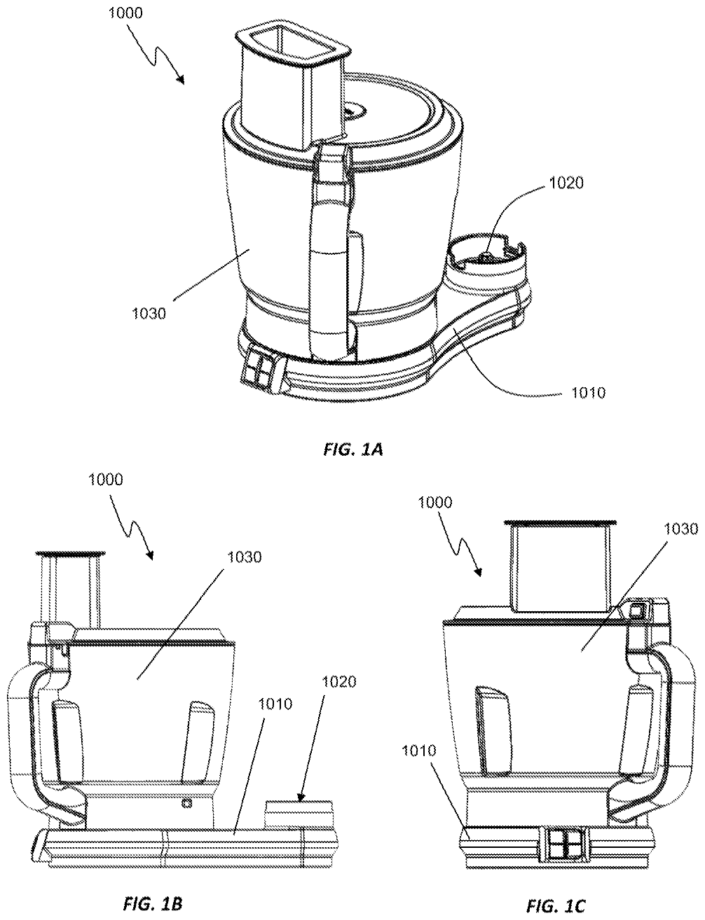

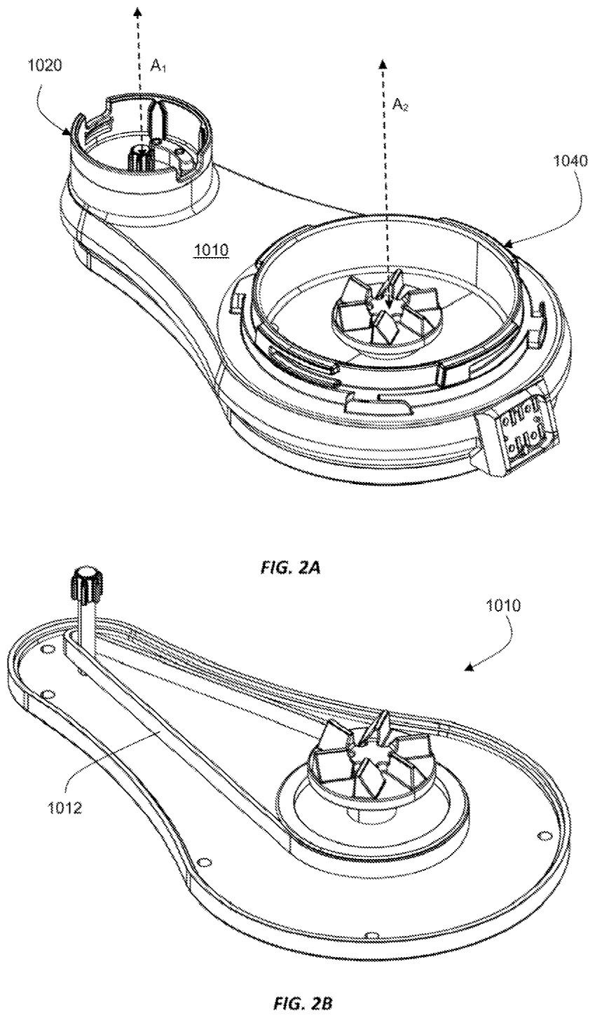

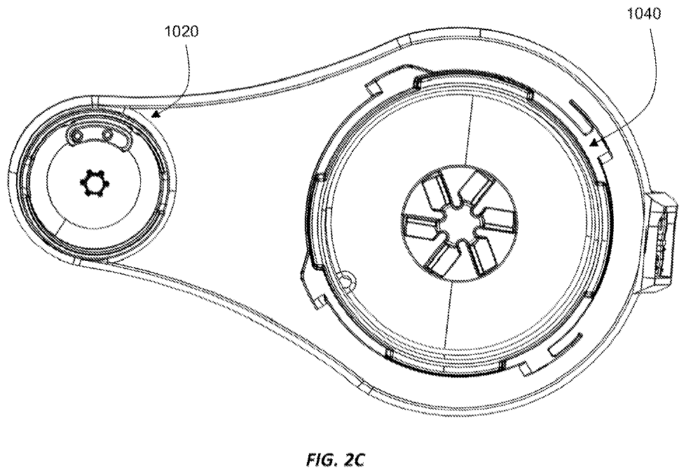

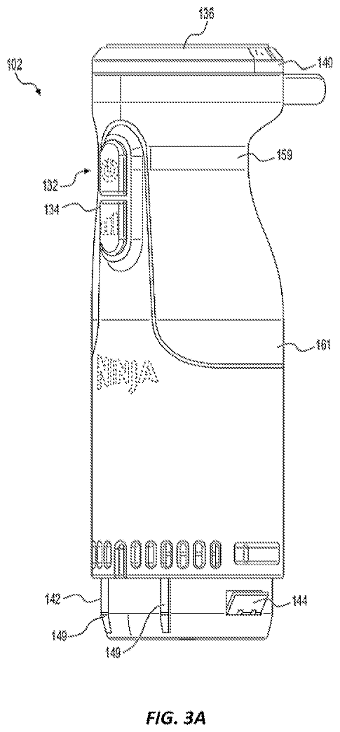

FIGS. 1A-1C illustrate an exemplary food processing attachment 1000 configured in accordance with the subject disclosure. FIG. 1A illustrates a perspective view of the food processing attachment 1000, FIG. 1B illustrates a front view of the food processing attachment 1000, and FIG. 1C illustrates a side view of the food processing attachment 1000. The food processing attachment 1000 includes a base attachment housing 1010 that can operatively couple to a removable accessory attachment 1030. FIGS. 1A-1C illustrate the base attachment housing 1010 coupled to an accessory attachment 1030 and FIGS. 2A-28 illustrate the base attachment housing 1010 without accessory attachment 1030. It should be understood that all references made herein to ‘food processing attachment 1000’ (alternatively referred to simply as ‘attachment 1000’) are meant to include the base attachment housing 1010, with or without the presence of accessory attachment 1030.

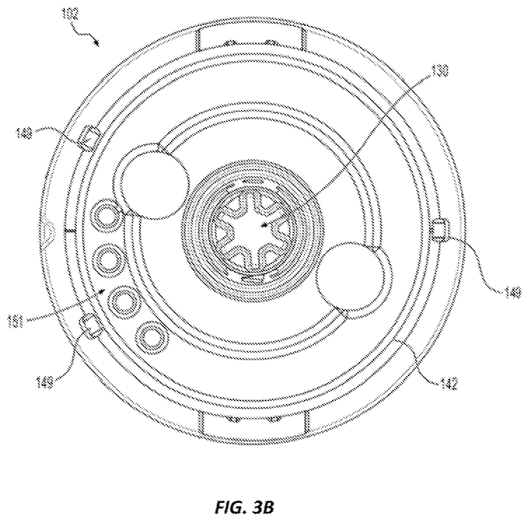

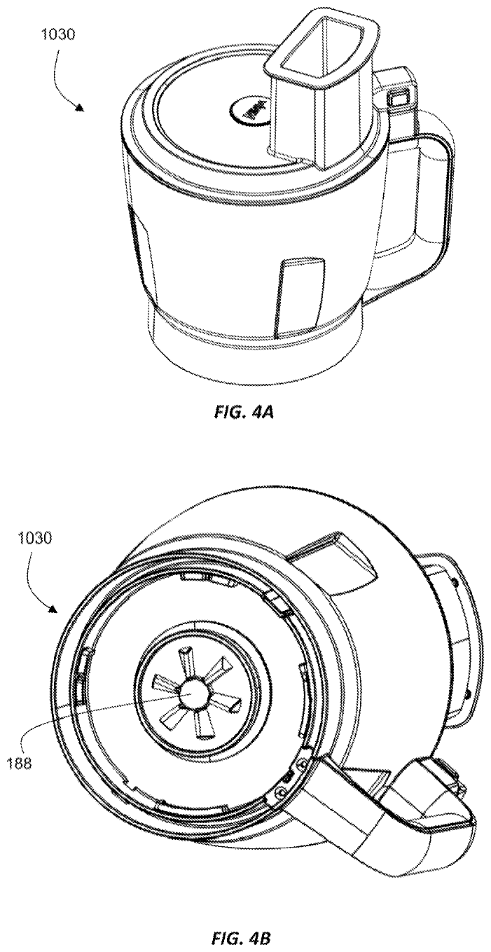

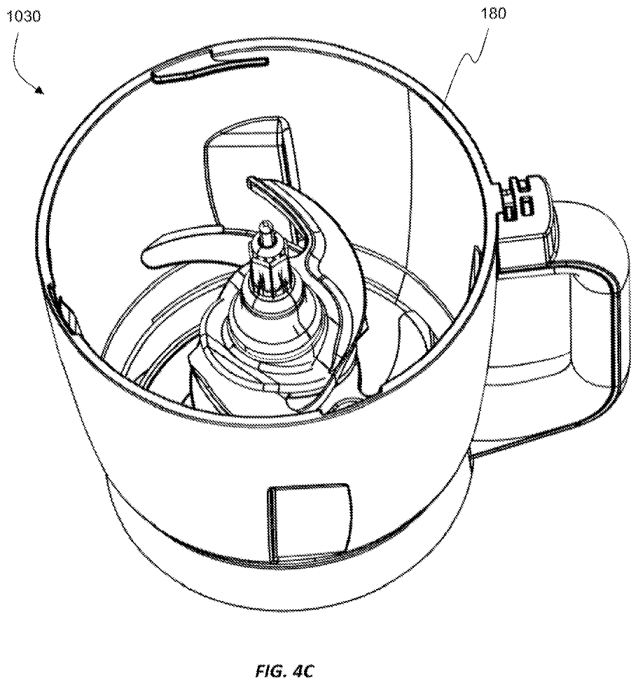

As shown in FIGS. 2A-2C, the base attachment housing 1010 includes a first port 1020 and a second port 1040. FIG. 2C illustrates exemplary features of first port 1020 and second port 1040. The first port 1020 is configured to releasably receive a motorized base housing 102 (discussed in more detail with respect to FIGS. 3A-3B) and the second port 1040 is configured to releasably receive an accessory attachment 1030 (discussed in more detail with respect to FIGS. 4A-4C). More specifically, the first port 1020 is configured to receive one or more particular features of the motorized base housing 102 and the second port 1040 is configured to receive one or more particular features of the accessory attachment 1030. For example, in some implementations, the first port may be configured to receive a drive coupler 130 of the motorized base housing 102 (see FIG. 31) and the second port may be configured to receive a central rotating member 188 of an accessory attachment 1030 (see FIG. 4B). The motorized base housing 102 and the accessory attachment 1030 are thus detachably connectable to the base attachment housing 1010 via the first port 1020 and the second port 1040, respectively.

The base attachment housing 1010 includes a drive transfer assembly 1012 configured to couple the first port 1020 to the second port 1040. More particularly, the drive transfer assembly 1012 is configured to transfer rotational motion of the drive coupler 130 to drive rotational motion of a central rotating member 188 of the accessory attachment 1030 when the motorized base housing 102 and the accessory attachment 1030 are connected to the first port 1020 and second port 1040, respectively. The drive transfer assembly 1012 includes at least one of a belt drive and a gear train to drive rotational motion of the central rotating member 188 within the accessory attachment 1030.

The drive transfer assembly 1012 may be configured to transfer rotation from the drive coupler 130 to the central rotating member 188 at any desired ratio. For example, the drive transfer assembly 1012 may transfer rotation from the drive coupler 130 to the central rotating member 188 at a ratio of 1:1 (i.e., the drive coupler 130 and the central rotating member 188 each have the same number of revolutions per minute (RPM)). In other cases, however, the drive transfer assembly 1012 may be configured to provide 2×, 3×, 4×, or more rotation to the central rotating member 188 as received from the drive coupler 130. In these and other cases, the drive transfer assembly 1012 may be configured to drive the central rotating member 188 at a rate of 3,000-4,000 RPM.

As shown in FIG. 2A, the first port 1020 is positioned to allow an attached drive coupler 130 to rotate about a first axis (A₁) and the second port is positioned to allow an attached central rotating member 188 to rotate about a second axis (A₂). The first axis (A₁) is parallel to and offset from the second axis (A₂).

The first port 1020 of the base attachment housing 1010 may use any type of suitable connector architecture to securely yet releasably retain the motorized base housing 102. Similarly, the second port 1040 of the base attachment housing 1010 may use any type of suitable connector architecture to securely yet releasably retain the accessory attachment 1030. Several particular attachment configurations for the first port 1020 and the second port 1040 are discussed in more detail below with respect to FIGS. 3A-3B (for coupling the motorized base housing 102 to the first port 1020) and FIGS. 4A-4B (for coupling the accessory attachment 1030 to the second port 1040).

FIGS. 3A-3B illustrate an exemplary motorized base housing 102 that may be releasably coupled to the base attachment housing 1010. The motorized base housing 102 can be operatively connected to various types of attachments, depending on a desired food processing action needed, including ‘attachment 1000’ discussed in detail herein. However, in other circumstances, motorized base housing 102 may be operatively connected to a different type of attachment, such as an immersion blender, single or double beaters, whisks, or dough hooks. The motorized base housing 102 may thus be couplable to types of componentry other than those described herein.

While not distinctly shown, the motorized base housing 102 includes a motor assembly which ultimately effectuates rotational movement within an attachment (i.e., attachment 1000) for food processing. This can be accomplished by a conventional motor, as is known in the art. For example, the motor assembly can include an electric motor powered by a DC voltage from a battery or through an AC voltage from a battery within the motorized base housing 102. Power can drive a motor shaft which can be translated into a shaft of an attachment 1000 via a drive coupler 130, gear assembly, or other mechanism within the motorized base housing 102.

The distal end and/or attachment receiver 142 of the motorized base housing 102 includes a mechanism for mechanically attaching the motorized base housing 102 to the attachment 1000 (specifically, to attach the motorized base housing 102 to the base housing attachment 1010 of attachment 1000). The motorized base housing 102 may include outwardly biased tabs 144 (note that while only one tab 144 is visible in FIG. 3A, the motorized base housing 102 may include a plurality of tabs 144, such as 2, 3, 4, or more tabs 144). The tabs 144 slope outwardly from the distal end 142 to the proximal end 140 of the motorized base housing 102. The base attachment housing 1010 may include corresponding attachment areas within the first port 1020 which include grooves designed to retain the tabs 144. Features of the first port 1020 can slide over the distal end 142 of the motorized base housing 102, allowing the tabs 144 to be depressed inward. Once the tabs 144 align with the grooves, the tabs are biased (e.g., through a spring or otherwise) to extend outward and into the grooves, locking in place and locking the motorized base housing 102 to the base attachment housing 1010.

The motorized base housing 102 may, in some circumstances, also include a quick release mechanism, such as a push button on the user control 132, which can be actuated to depress the tabs 144 and the release it from the base attachment housing 1010. In such cases, the motorized base housing 102 can be quickly and effectively attached to, or removed from, the base attachment housing 1010 to provide for speedy transition between various food processing operations.

Additionally or alternatively, the distal end and/or attachment receiver 142 of the motorized base housing 102 can include ribs 149 which couple with grooves within the first port 1020. The ribs 149 protrude from the distal end and/or attachment receiver 142 of the motorized base housing 102 and run axially down the length of the motorized base housing 102. The grooves within the first port 1020 are correspondingly shaped channels, which allow the grooves to receive the ribs 149 and guide the distal end and/or attachment receiver 142 of the motorized base housing 102 into the corresponding attachment area and/or attachment interface. After the food processing attachment 1000 is attached to the motorized base housing 102, the engagement between the ribs 149 and grooves also helps rotationally lock the motorized base housing 102 to the base housing attachment 1010. Note, while three ribs 149 and corresponding grooves have been found to be effective, it should be understood that other numbers can also be used, such as two, four, or six, and so on.

In some implementations, the motorized base housing 102 may include a set of user controls 132 (shown in FIG. 3A) which allow a user to control a power setting and a variable speed of the motor (in a user-controllable operational setting) to drive an accessory attachment 1030 coupled to the base attachment housing 1010.

FIGS. 4A-4C illustrate an exemplary accessory attachment 1030 that may be releasably coupled to the base attachment housing 1010. As shown in FIGS. 4A-4C the accessory attachment 1030 may include a vessel 180 and a central rotating member 188 positioned to rotate within the vessel. During use, food can be placed within the vessel 180 for processing, and the vessel 180 can then be sealed, if desired.

The accessory attachment 1030 may be designed to perform any desired type of food processing operation. For example, accessory attachment 1030 may include one or more of the following: a blender, a chopper, a mixer, a frother, a vacuum sealer, a grinder, a food processor, juicer, spiralizer, and a direct prepper. If desired, the central rotating member 188 may be outfitted with a number of separate, vertically offset blades, as shown in FIG. 4C.

The base of the accessory attachment 1030 may include componentry configured to releasably couple to the second port 1040. For example, in some implementations, the second port 1040 and the base of the accessory attachment 1030 may be coupled by friction fit, snap-fit, or with bayonet fittings. In select implementations, the second port 1040 includes two or more bayonet slots keyed to receive corresponding bayonet tabs of the accessory attachment 1030. In some such implementations, clockwise movement of the accessory attachment 1030 on the second port 1040 can attach the accessory attachment 1030 to the second port 1040 and counterclockwise movement of the accessory attachment 1030 can release the accessory attachment 1030 from the second port 1040. Although an example bayonet fitting attachment scheme is illustrated in FIGS. 4A-4C, one of ordinary skill in the relevant art will appreciate that numerous alternative coupling mechanisms for the accessory attachment 1030 are possible and contemplated herein.

In some implementations, the accessory attachment 1030 may include interlocks and/or electrical contacts, which may be pogo type pins or electrodes and the base attachment housing 1010 may include corresponding and/or mating interlocks or electrical contacts within the second port 1040 that engage with the electrical contacts of the accessory attachment 1030 when the accessory attachment 1030 is coupled to the second port 1040 of the base attachment housing 1010. In select implementations, the attachment 1000 may be configured to alter the speed settings of the motorized base housing 102 based on the type of accessory attachment 1030 that is detected. Such implementations are discussed in further detail below.

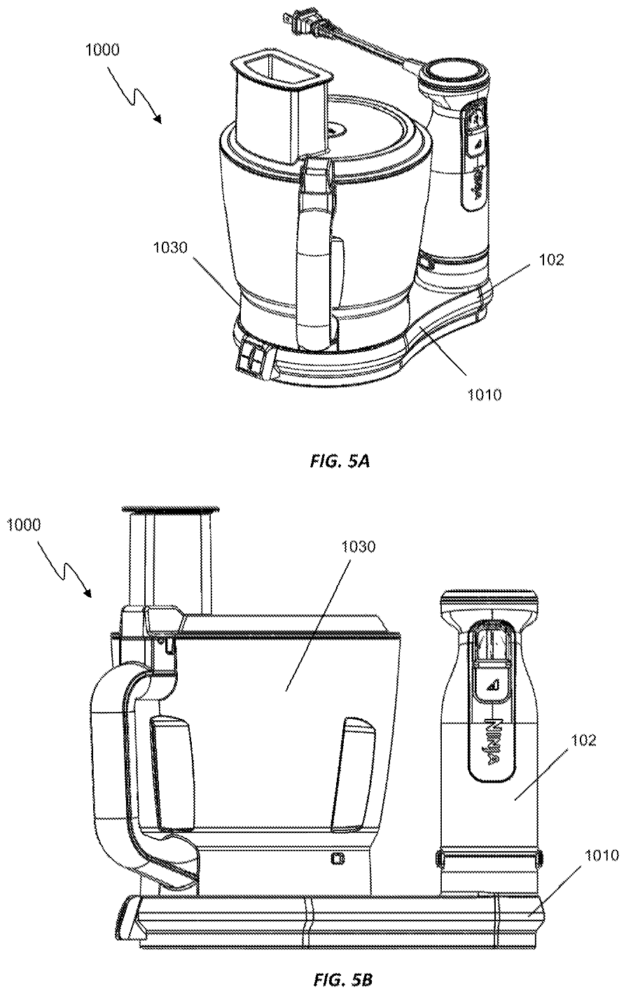

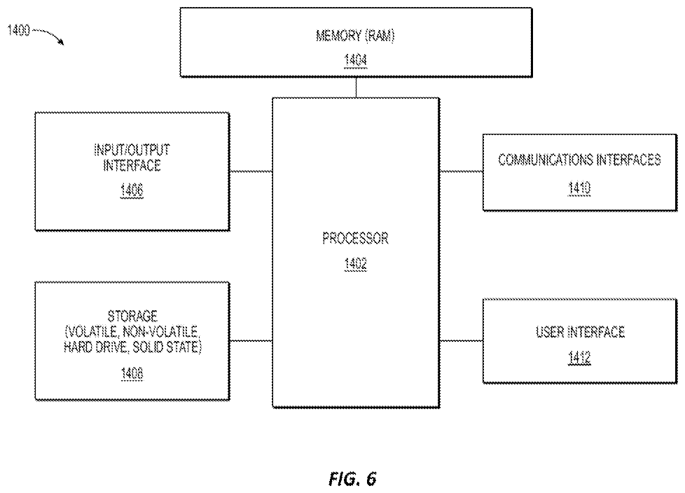

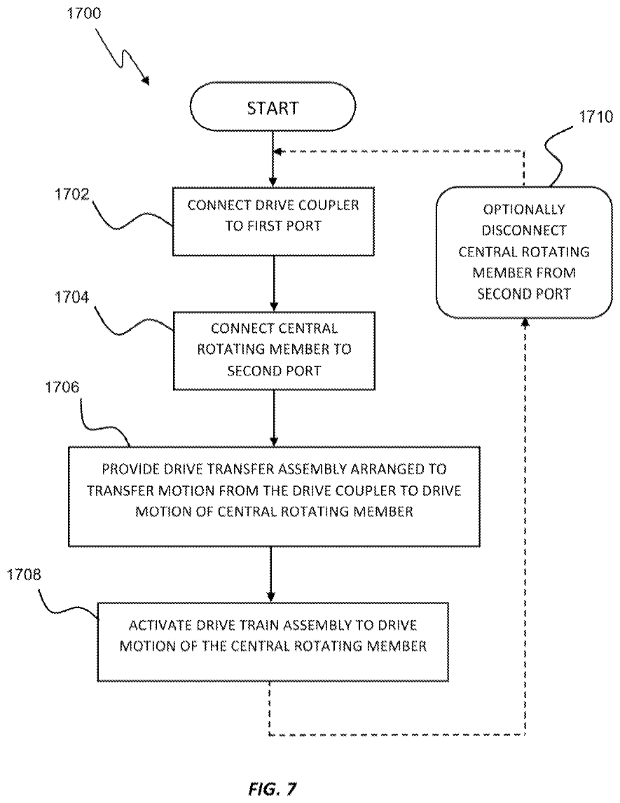

FIGS. 5A-5B illustrate an exemplary food processing device 100 in which a motorized base housing 102 and an accessory attachment 1030 arc coupled to the base attachment housing 1010. Particular details of the motorized base housing 102, the accessory attachment 1030, and the base attachment housing 1010 have previously been discussed in detail herein. Although a single food processing device 100 is shown in FIGS. 5A-5B, one of ordinary skill in the art will appreciate that other types of kitchen tools and/or food processing devices may be configured to interchangeably receive, identify, and/or control multiple types of food processing attachments 1000 (and accessory attachments 1030) in addition to those described and illustrated herein.

In some implementations, the food processing device 100 may include a computer system. If present, the computer system may be contained within the base attachment housing 1010 and/or the motorized base housing 102. The computer system may enable the food processing device 100 to detect the type of accessory attachment 1030 coupled to the base attachment housing 1010 and, if desired, automatically adjust the output from the motorized base housing 102 based on the type of accessory attachment 1030 detected.

FIG. 6 is a block diagram of an illustrative computer system 1400 that may be housed within the food processing device 100. Computer system 1400 may include a system-on-a-chip (SoC), a client device, and/or a physical computing device and may include hardware and/or virtual processor(s). In some implementations, computer system 1400 and its elements as shown in FIG. 6 each relate to physical hardware and in some implementations one, more, or all of the elements could be implemented using emulators or virtual machines. Regardless, computer system 1400 may be implemented on physical hardware.

As also shown in FIG. 6, computer system 1400 may include a user interface 1412, having, for example, a keyboard, keypad, touchpad, or sensor readout (e.g., biometric scanner) and one or more output devices, such as displays, speakers for audio, LED indicators, and/or light indicators. Computer system 1400 may also include communications interfaces 1410, such as a network communication unit that could include a wired communication component and/or a wireless communications component, which may be communicatively coupled to processor 1402. The network communication unit may utilize any of a variety of proprietary or standardized network protocols, such as Ethernet. TCP/IP, to name a few of many protocols, to effect communications between processor X00 and another device, network, or system. Network communication units may also comprise one or more transceivers that utilize the Ethernet, power line communication (PLC), Wi-Fi, cellular, and/or other communication methods.

Computer system 1400 includes a processing element, such as processor 1402, that contains one or more hardware processors, where each hardware processor may have a single or multiple processor cores. In one implementation, the processor 1402 includes at least one shared cache that stores data (e.g., computing instructions) that are utilized by one or more other components of processor 1402. For example, the shared cache may be a locally cached data stored in a memory for faster access by components of the processing elements that make up processor 1402. Examples of processors include, but are not limited to a central processing unit (CPU) and/or microprocessor. Processor 1402 may utilize a computer architecture base on, without limitation, the Intel® 8051 architecture, Motorola® 68HCX, Intel® 80X86, and the like. The processor 1402 may include, without limitation, an 8-bit, 12-bit, 16-bit, 32-bit, or 64-bit architecture. Although not illustrated in FIG. 6, the processing elements that make up processor 1402 may also include one or more other types of hardware processing components, such as graphics processing units (GPUs), application specific integrated circuits (ASICs), field-programmable gate arrays (FPGAs), and/or digital signal processors (DSPs).

FIG. 6 illustrates that memory 1404 may be operatively and communicatively coupled to processor 1402. Memory 1404 may be a non-transitory medium configured to store various types of data. For example, memory 1404 may include one or more storage devices 1408 that include a non-volatile storage device and/or volatile memory. Volatile memory, such as random-access memory (RAM), can be any suitable non-permanent storage device. The non-volatile storage devices in storage 1408 may include one or more disk drives, optical drives, solid-state drives (SSDs), tape drives, flash memory, read-only memory (ROM), and/or any other type memory designed to maintain data for a duration time after a power loss or shut down operation. In certain configurations, the non-volatile storage devices 1408 may be used to store overflow data if allocated RAM is not large enough to hold all working data. The non-volatile storage devices 1408 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 1402. In one implementation, the compiling process of the software program may transform program code written in a programming language to another computer language such that the processor 1402 is able to execute the programming code. For example, the compiling process of the software program may generate an executable program that provides encoded instructions (e.g., machine code instructions) for processor 1402 to accomplish specific, non-generic, particular computing functions.

After the compiling process, the encoded instructions may be loaded as computer executable instructions or process steps to processor 1402 from storage 1408, from memory X04, and/or embedded within processor 1402 (e.g., via a cache or on-board ROM). Processor 1402 may be configured to execute the stored instructions or process steps in order to perform instructions or process steps to transform the computing device into a non-generic, particular, specially programmed machine or apparatus. Stored data, e.g., data stored by a storage device 1408, may be accessed by processor 1402 during the execution of computer executable instructions or process steps to instruct one or more components within computing system 1400 and/or other components or devices external to system 1400.

User interface 1412 can include a display, positional input device (such as a mouse, touchpad, touchscreen, or the like), keyboard, keypad, one or more buttons, or other forms of user input and output devices. The user interface components may be communicatively coupled to processor 1402. When the user interface output device is or includes a display, the display can be implemented in various ways, including by a liquid crystal display (LCD) or a cathode-ray tube (CRT) or light emitting diode (LED) display, such as an OLED display. Persons of ordinary skill in the art are aware that computer system 1400 may include other components well known in the art, such as power sources and/or analog-to-digital converters, not explicitly shown in FIG. 6.

In some implementations, computing system 1400 and/or processor 1402 includes an SoC having multiple hardware components, including but not limited to:
a microcontroller, microprocessor or digital signal processor (DSP) core and/or multiprocessor SoCs (MPSoC) having more than one processor cores;
memory blocks including a selection of read-only memory (ROM), random access memory (RAM), electronically erasable programmable read-only memory (EEPROM) and flash memory;
timing sources including oscillators and phase-docked loops;
peripherals including counter-timers, real-time timers and power-on reset generators; external interfaces, including industry standards such as universal serial bus (USB), FireWire, Ethernet, universal synchronous/asynchronous receiver/transmitter (USART), serial peripheral interface (SPI);
analog interfaces including analog-to-digital converters (ADCs) and digital-to-analog converters (DACs); and
voltage regulators and power management circuits.

A SoC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

Once the overall architecture of the SoC has been defined, individual hardware elements may be described in an abstract language called RTL which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some implementations, some or all of the components of computer system 1400 are implemented on a printed circuit board (PCB). One or more features of computing system 1400 may be incorporated within the devices described with respect to FIGS. 5A and 5B or any other devices described herein.

It will be apparent to those of ordinary skill in the art that certain aspects involved in the operation of food processing device 100 and an attachment 1000 (with or without accessory attachment 1030), and respective processors if present, may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

The food processing device 100 illustrated in FIGS. 5A and 5B may include two or more different operational settings for controlling the motor, if desired. For example, in a first operational setting, the motorized base housing 102 may control the motor assembly to drive rotation of the central rotating member 188 of the accessory attachment 1030. The first operational setting may allow the motorized base housing 102 to attach to and control the base attachment housing 1010 (and thus accessory attachment 1030), or other attachment which has no control mechanism of its own. Alternatively, the food processing device 100 may include controls to disable or override the controls of the motorized base housing 102, thereby allowing the food processing device 100 to operate in a second operational mode whereby the rotation of the central rotating member 188 within the accessory attachment 1030 is controlled by controls of the food processing attachment 1000 (e.g., based on the type of accessory attachment 1030 detected).

In some cases, the power state and motor speed of the food processing device 100 may be controlled by a user control 132 on the motorized base housing 102. However, in other cases, attaching the motorized base housing 102 to the base attachment housing 1010 can automatically disable the user control 132 (and first operational mode) and enable a second operational mode. In the second operational mode, the power state and motor speed of the food processing device 100 is based on the type of accessory attachment 1030 detected as being coupled to the base attachment housing 1010.

FIG. 7 includes a flow diagram of a process 1700 for using a food processing device 100 having a food processing attachment 1000 as described herein. Process 1700 begins by connecting a drive coupler of a motorized base housing to a first port of a base attachment housing (Step 1702). Process 1700 continues with connecting a central rotating member of an accessory attachment to a second port of the base attachment housing (Step 1704). A drive transfer assembly is provided within the base attachment housing and the drive transfer assembly is arranged to transfer a motion of the drive coupler to a motion of the central rotating member (Step 1706). Process 1700 continues with activating the motorized base housing to drive rotational movement of the central rotating member via the drive transfer assembly (Step 1708). Process 1700 optionally includes disconnecting the central rotating member from the second port (Step 1710).

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology. For example, each claim may depend from any or all claims in a multiple dependent manner even though such has not been originally claimed.

What is claimed is:

1. A food processing attachment for a food processing device comprising:
a base attachment housing including:
a first port configured to receive a drive coupler of a detachably connectable motorized base housing;
a second port configured to receive a central rotating member of a detachably connectable accessory attachment; and
a drive transfer assembly configured to couple the first port to the second port;
wherein the drive transfer assembly is configured to transfer rotational motion of the drive coupler to drive rotational motion of the central rotating member of the accessory attachment when the motorized base housing and the accessory attachment are connected to the first port and second port respectively.

2. The food processing attachment of claim 1, wherein the accessory attachment further comprises a vessel and the central rotating member is positioned to rotate within the vessel.

3. The food processing attachment of claim 1, wherein the drive transfer assembly includes at least one of a belt drive and a gear train to drive rotational motion of the central rotating member.

4. The food processing attachment of claim 1, wherein the accessory attachment is selected from the group consisting of: a blender, a chopper, a mixer, a frother, a vacuum sealer, a grinder, a food processor, juicer, spiralizer, and a direct prepper.

5. The food processing attachment of claim 1, wherein the drive coupler rotates about a first axis and the central rotating member rotates about a second axis, and the first axis is parallel to the second axis.

6. The food processing attachment of claim 5, wherein the first axis is offset from the second axis.

7. The food processing attachment of claim 1, wherein the second port includes one or more interlocks to detect the accessory attachment coupled to the base attachment housing.

8. The food processing attachment of claim 7, wherein the motorized base housing is configured to adjust a speed of the drive coupler based on the accessory attachment detected.

9. A food processing device comprising:
a motorized base housing comprising a drive coupler configured to rotate about a first axis;
an accessory attachment comprising a central rotating member configured to rotate about a second axis; and
a base attachment housing comprising a first port configured to receive the drive coupler and a second port configured to receive the central rotating member;
wherein the base attachment housing further comprises a drive transfer assembly arranged to transfer rotational motion of the drive coupler to drive rotational motion of the central rotating member.

10. The food processing device of claim 9, wherein the first axis is parallel to and offset from the second axis.

11. The food processing device of claim 9, wherein the drive transfer assembly includes a belt drive or a gear train.

12. A method of using a food processing device comprising:
connecting a drive coupler of a motorized base housing to a first port of a base attachment housing;
connecting a central rotating member of an accessory attachment to a second port of the base attachment housing;
providing a drive transfer assembly within the base attachment housing arranged to transfer a motion of the drive coupler to a motion of the central rotating member; and
activating the motorized base housing to drive rotational movement of the central rotating member via the drive transfer assembly.
